(19) United States
(12) Patent Application Publication
(10) Pub. No.: US 2023/0108811 A1
(43) Pub. Date: Apr. 6, 2023

(54) A POWDER FOR USE IN THE NEGATIVE ELECTRODE OF A BATTERY, A METHOD FOR PREPARING SUCH A POWDER AND A BATTERY COMPRISING SUCH A POWDER

(71) Applicant: UMICORE, Brussels (BE)

(72) Inventors: Boaz MOEREMANS, Olen (BE); Nicolas MARX, Olen (BE); Jean-Sébastien BRIDEL, Olen (BE); Stijn PUT, Olen (BE)

(21) Appl. No.: 17/904,496

(22) PCT Filed: Feb. 9, 2021
(86) PCT No.: PCT/EP2021/053095

§ 371 Date: Aug. 18, 2022

(30) Foreign Application Priority Data
Feb. 21, 2020 (EP) 20158775.5

(51) Int. Cl. H01M 4/38; H01M 4/36; H01M 4/62; H01M 4/04

(52) U.S. Cl. CPC H01M 4/386; H01M 4/364; H01M 4/625; H01M 4/0471; H01M 2004/021

(57) ABSTRACT

A silicon-based powder suitable for use in a negative electrode of a battery. The silicon-based powder comprises silicon-based particles and non-silicon-based particles. The silicon-based particles have a number-based particle size distribution with a d_{S}50 value, being at most 200 nm. The silicon-based powder has an oxygen content of at most 20% by weight and comprises one or more elements M from a group of metals that have a Standard Gibbs free energy of formation at a temperature T of the oxide from their zerovalent state which is lower than the Standard Gibbs free energy of formation at the same temperature T of SiO₂ from zerovalent silicon. The temperature T is equal to or higher than 573K and lower than 1373K. The content of said one or more elements M in the silicon-based powder is at least 0.10% of the content of Si by weight in said silicon-based powder.

### TECHNICAL FIELD AND BACKGROUND

The present invention relates to a powder for use in the negative electrode of a battery, to a method for preparing such a powder and to a battery comprising such a powder.

Lithium ion (Li-ion) batteries are currently the best performing batteries and already became the standard for portable electronic devices. In addition, these batteries already penetrated and rapidly gain ground in other industries such as automotive and electrical storage. Enabling advantages of such batteries are a high-energy density combined with a good power performance.

A Li-ion battery typically contains a number of so-called Li-ion cells, which in turn contain a positive electrode, also called cathode, a negative electrode, also called anode, and a separator which are immersed in an electrolyte. The most frequently used Li-ion cells for portable applications are developed using electrochemically active materials such as lithium cobalt oxide or lithium nickel manganese cobalt oxide for the cathode and a natural or artificial graphite for the anode.

It is known that one of the important limitative factors influencing a battery's performance and in particular a battery's energy density is the active material in the anode. Therefore, to improve the energy density, the use of electrochemically active materials comprising silicon, in the negative electrode, has been investigated over the past years.

In the art, the performance of a battery containing Si-based electrochemically active powders is generally quantified by a so-called cycle life of a full-cell, which is defined as the number of times or cycles that a cell comprising such material can be charged and discharged until it reaches 80% of its initial discharge capacity. Most works on silicon-based electrochemically active powders are therefore focused on improving said cycle life.

A drawback of using a silicon based electrochemically active material in an anode is its large volume expansion during charging, which is as high as 300% when the lithium ions are fully incorporated, e.g. by alloying or insertion, in the anode's active material—a process often called lithiation. The large volume expansion of the silicon-based materials during lithium incorporation may induce stresses in the silicon-based particles, which in turn could lead to a mechanical degradation of the silicon material. Repeated periodically during charging and discharging of the Li-ion battery, the repetitive mechanical degradation of the silicon-based electrochemically active material may reduce the life of a battery to an unacceptable level.

Further, a negative effect associated with silicon is that a thick SEI, a Solid-Electrolyte Interface, may be formed on the anode. A SEI is a complex reaction product of the electrolyte and lithium, and therefore leads to a loss of lithium availability for electrochemical reactions and therefore to a poor cycle performance, which is the capacity loss per charging-discharging cycle. A thick SEI may further increase the electrical resistance of a battery and thereby limit the achievable charging and discharging rates.

In principle, the SEI formation is a self-terminating process that stops as soon as a ‘passivation layer’ has formed on the surface of the silicon-based material. However, because of the volume expansion of silicon-based particles, both silicon-based particles and the SEI may be damaged during discharging (lithiation) and recharging (de-lithiation), thereby freeing new silicon surface and leading to a new onset of SEI formation.

To solve the above-mentioned drawbacks, composite powders are usually used. In these composite powders, nano-sized silicon-based domains are mixed with at least one component suitable to protect the silicon-based domains from electrolyte decomposition and to accommodate volume changes, are usually used. Such a component may be a carbon-based material, preferably forming a matrix.

Such composite powders are mentioned, for example in US 2009/0162750, wherein silicon particles composed of crystal particles having a diameter of 5 nm to 200 nm and an amorphous surface layer having a thickness of 1 nm to 10 nm, formed of at least a metal oxide whose Gibbs free energy at the time of producing a metal oxide by oxidation of a metal element is smaller than the Gibbs free energy at the time of oxidizing silicon, are disclosed. In US 2009/0092899, an anode material including silicon, wherein the silicon is formed by combining fumed silicon oxide having an average particle size of less than approximately 100 nm, with a metal, the metal being selected from the group consisting of Mg, Ca, Al, Li, Na, K, Cs, Sr, Ba, Ti and Zr, is disclosed. In WO 2012/000858, a submicron-sized Si-based powder having an average primary particle size between 20 nm and 200 nm and a surface layer comprising SiOₓ with 0<x<2 and having an average thickness between 0.5 nm and 10 nm, is disclosed. In EP 3525267, silicon-based particles having a number-based distribution with a d50, whereby less than 8% of the particles have a size which is larger than twice the d50, is disclosed. In Novel Nanostructured SiO₂/ZrO₂ Based Electrodes with Enhanced Electrochemical Performance of Lithium-ion Batteries, Electrochemica Acta 218 (2016) 47-53, an anode material made of SiO₂/ZrO₂ and forming Si—O—Zr bonds, is disclosed.

Despite the use of such composite powders, there is still room for improvement of the performance of batteries containing Si-based electrochemically active powders.

Another drawback associated with the presence of fine silicon-based particles in the anode is that these silicon-based particles have an oxide layer on their surface. Depending on the particle size and the way the silicon-based particles are manufactured, this can lead to an oxygen content in the silicon-based particles from a few wt % up to 15 wt % or even higher.

When used in a battery, the oxygen comprised in the silicon-based particles will react with the lithium, which will result in the conversion of part of the lithium into lithium oxide (Li₂O). Since the amount of lithium in a commercial battery is limited to what is comprised in the cathode, when part of this lithium is irreversibly converted into lithium oxide which cannot be used for further charge/discharge cycles, the initial irreversible capacity loss for the battery increases.

Therefore, any measure that can be taken to reduce the oxygen content of the silicon-based particles will directly contribute to the reduction of the amount of lithium converted into lithium oxide and thus to a reduction of the initial irreversible capacity loss (i.e. an increase of the initial coulombic efficiency) of batteries containing such silicon-based particles.

It is an object of the present invention to provide a stable electrochemically active silicon-based powder comprising silicon-based particles having a reduced amount of oxygen, silicon-based powder which once used in the negative electrode in the Li-ion battery, is advantageous in that it allows achieving a reduced initial irreversible capacity loss of the battery.

### SUMMARY OF THE INVENTION

This objective is achieved by providing a silicon-based powder according to Embodiment 1, said silicon-based powder, which once used in the anode of the Li-ion battery, allows achieving a higher initial coulombic efficiency (CE), as demonstrated in Examples 1 to 5 compared to Counterexample 1 and in Example 6 compared to Counterexample 2.

The present invention concerns the following embodiments:

### Embodiment 1

In a first aspect, the invention concerns a silicon-based powder suitable for use in a negative electrode of a battery, the silicon-based powder comprising silicon-based particles and non-silicon-based particles, the silicon-based particles having a number-based particle size distribution with a d_{S}50 value, the d_{S}50 value being at most 200 nm, the silicon-based powder having an oxygen content of at most 20% by weight, the silicon-based powder comprising one or more elements M from a group of metals that have a Standard Gibbs free energy of formation at a temperature T of the oxide from their zerovalent state which is lower than the Standard Gibbs free energy of formation at the same temperature T of SiO₂ from zerovalent silicon, the temperature T being equal to or higher than 573K and lower than 1373K, the content of said one or more elements M in the silicon-based powder being of at least 0.10% of the content of Si by weight in said silicon-based powder and at most 5.0% of the content of Si by weight in said silicon-based powder, the one or more elements M being present in the non-silicon-based particles.

In other words, the silicon-based powder according to Embodiment 1, comprises both silicon-based particles and non-silicon-based particles, the latter containing the one or more elements M.

By a powder suitable for use in the negative electrode of a battery, it is meant an electrochemically active powder, comprising electrochemically active particles, which are able to store and release lithium ions, respectively during the lithiation and the delithiation of the negative electrode of a battery. Such a powder may equivalently be referred to as “active powder”.

By a silicon-based powder (or particle), it is meant a powder (or a particle) comprising silicon as the main metal (or semi-metal) element or as the sole metal (or semi-metal) element. The silicon is present in its majority as silicon metal (or semi-metal), to which minor amounts of other materials may have been added to improve properties, or which may contain some unavoidable impurities, such as oxygen. The average Si content in such a silicon-based powder (or particle) may be 60 weight % or more, or may be 70 weight % or more, or may be 80 weight % or more with respect to the total weight of the silicon-based powder (or particle).

The silicon-based particles may have any shape, e.g. substantially spherical but also irregularly shaped, rod-shaped, plate-shaped, etc.

The elements M, from a group of metals having a Standard Gibbs free energy of formation at a temperature T of the oxide from their zerovalent state which is lower than the Standard Gibbs free energy of formation at the same temperature T of SiO₂ from zerovalent silicon, the temperature T being equal to or higher than 573K and lower than 1373K, may for example be Zr, Al, Mg, Ti and Ca.

For the avoidance of doubt, it is made clear that in this document the word ‘silicon’ refers to the element Si in its metal, zerovalent, state, and the symbol Si refers to the element silicon irrespective of its oxidation state. This is analogously the case for other elements, such as Zr, Al, Mg, Ca, Ti, where the full name of the metal refers to the element in its metal, zerovalent, state, and the symbol of the element refers to the element irrespective of its oxidation state.

During the preparation of the silicon-based powder of Embodiment 1, starting from an original silicon-based powder, the one or more elements M will react with the oxygen comprised in the original silicon-based particles, oxygen present for example in the surface layer of the original silicon-based particles as silicon oxide SiO_{x′} with 0<x′<2, to form one or more metal M oxides and silicon-based particles with a reduced oxygen content. This may be achieved for example by intensively mixing, for instance in a high-energy ball mill, the original silicon-based powder with a certain amount of M-based powder comprising M-based particles having a MO_{y′} surface layer with 0≤y′<2. As a result, the silicon-based particles in the silicon-based powder have a surface layer with an average molar composition SiOₓ with 0≤x<x′ and the M-based particles in the silicon-based powder have a surface layer with an average molar composition MO_{y′} with 0≤y′<y.

By a surface layer with an average molar composition SiO_{x′} with 0<x′<2, it is meant an average value of the molar compositions determined by XPS analysis at each of at least 3 different points (or positions) of the analysed sample of the powder. The same applies to an average molar composition MO_{y′} with 0≤y′<2 and to any other average molar composition mentioned in the present document.

The content of the one or more elements M in the silicon-based powder of Embodiment 1 needs to be at least 0.10% of the content of Si by weight to ensure that a significant effect, in terms of oxygen reduction in the silicon-based particles, is obtained.

A too high content of the one or more elements M should be avoided to prevent a too high dilution of the silicon-based powder with materials that do not contribute to the specific capacity in a battery.

By surface layer of a particle it is meant a layer on the surface of the core of the particle, the core being a metal, for example Si or Zr. The surface layer is generally an oxide layer having as composition AOₓ where A is the metal constituting the core of the particle and x is smaller than the maximum value it can have in case of a fully oxidized layer. The surface layer of a particle usually has a thickness which does not exceed one tenth of the diameter of the core of the particle. In the present invention, the surface layer of a particle has a thickness which does not exceed 20 nm, preferably a thickness which does not exceed 10 nm.

It is important to mention that the milling of the original silicon-based powder with the M-based powder should not be too intensive, to avoid the formation of SiM alloys, such as for example SiZr alloys, which are electrochemically inactive and thus would lower the specific capacity of the silicon-based powder obtained.

The presence of the one or more elements M in particles distinct from the silicon-based particles has two advantages. Firstly, it avoids the processing step of making a Si-M metallic alloy, and secondly it allows, if needed, for the later removal of the metal M oxide particles from the silicon-based powder, which would result in a lower amount of non-electrochemically active particles in the silicon-based powder and thus a higher specific capacity of the silicon-based powder in a battery.

The composition of the surface layers is analysed using suitable techniques, such as for example X-ray photoelectron spectrometry (XPS) or Nuclear magnetic resonance (NMR). These techniques allow either to quantify the x and y value of the SiOₓ and MO_{y} surface layer, or at least to quantitatively compare x′ and x from SiO_{x′} and SiOₓ, to confirm the decrease in the oxygen content of the silicon-based particles when producing a silicon-based powder according to Embodiment 1, starting from an original silicon-based powder having silicon-based particles with an SiO_{x′} surface layer.

### Embodiment 2

In a second embodiment according to Embodiment 1, the silicon-based particles have a surface layer with an average molar composition SiOₓ with 0≤x<1.

### Embodiment 3

In a third embodiment according to Embodiment 1 or 2, when considering all elements except oxygen, the content of said one or more elements M in said non-silicon-based particles is at least 60% by weight.

A too low content of the one or more elements M in the non-silicon-based particles would require a higher concentration of non-silicon-based particles to be present in the silicon-based powder, in order to achieve the desired technical effect. Since the non-silicon-based particles are electrochemically inactive, this would lower the specific capacity (in mAh/g) of the silicon-based powder.

### Embodiment 4

In a fourth embodiment according to any one of the Embodiments 1 to 3, the non-silicon-based particles have a particle size distribution with a d_{NS}50, the d_{NS}50 value being at most 500 nm.

Non-silicon-based particles of a larger size would have a lower surface area and thus a lower reactivity towards the oxygen comprised in the silicon-based particles. It would therefore require a higher concentration of non-silicon-based particles to be present in the silicon-based powder, which would lower the specific capacity (in mAh/g) of the silicon-based powder, in order to achieve the desired technical effect.

### Embodiment 5

In a fifth embodiment according to any one of the Embodiments 1 to 4, the content of said one or more elements M in said silicon-based powder is at least 0.40% of the content of Si by weight.

### Embodiment 6

In a sixth embodiment according to any one of the Embodiments 1 to 5, the group of one or more elements M comprises Zr.

In other words, at least one of the metal elements M is Zr. Preferably at least 50% by weight of metal elements M is Zr and more preferably at least 75% by weight of metal elements M is Zr.

More preferably, the group of one or more elements M comprises only Zr as metal element, besides the unavoidable metal impurities.

This may be beneficial because Zr, in its metal state, is harder than many of the other elements having a Standard Gibbs free energy of formation at a temperature T of the oxide from their zerovalent state which is lower than the Standard Gibbs free energy of formation at the same temperature T of SiO₂ from zerovalent silicon, the temperature T being equal to or higher than 573K and lower than 1373K, such as for example Al, Ca, and Mg. A Zr powder will not stick to the milling media or to the wall of the mixing vessel and thus will end up mixed with the silicon-based powder, whereas for Al, Ca and Mg powders there may be a loss of material, which is undesirable in itself, but also makes difficult to control the amount of such metals that will end up in the final silicon-based powder.

Zirconium therefore offers an optimal balance of practical usability and relatively easy availability at acceptable costs.

Preferably the content of Zr is at least 0.40% of the content of Si by weight in said silicon-based powder and at most 5% of the content of Si by weight in said silicon-based powder.

### Embodiment 7

In a seventh embodiment according to any one of the Embodiments 1 to 6, when considering all elements except oxygen, the Si content in the silicon-based powder is at least 90% by weight.

### Embodiment 8

In an eighth embodiment according to any one of the Embodiments 1 to 8, the silicon-based powder has a volumetric particle size distribution having an average primary particle size dₐᵥ, dₐᵥ being larger than or equal to 17 nm and smaller than or equal to 172 nm.

The average primary particle size dₐᵥ of the silicon-based powder may be determined based on a Centrifugal Photosedimentometer (CPS) analysis, or on a microscopy analysis or may be calculated from the specific surface area of the powder, assuming spherical particles of equal size, according to the formula from Rouquerol et. al in Adsorption by Powders and Porous Solids (1999):

$${d}_{a v} ( m ) = \frac{6}{ρ ( \frac{g}{{m}^{3}} ) \times B E T ( \frac{{m}^{2}}{g} )}$$

in which ρ refers to the theoretical density of the powder (2.33 g/cm³) and BET refers to the specific surface area (m²/g) of the powder as determined by the N₂ adsorption method of Brunauer-Emmett-Teller (BET technique).

In other words, based on the above-mentioned equation, a silicon-based powder having particles with an average primary particle size day being larger than or equal to 17 nm and smaller than or equal to 172 nm, is equivalent to a powder having a BET specific surface area higher than or equal to 15 m²/g and lower than or equal to 150 m²/g.

### Embodiment 9

In a second aspect, the invention concerns a method for preparing a silicon-based powder according to any one of the claims 1 to 8, comprising the steps of:
a. Providing a powder comprising silicon-based particles, having a volumetric particle size distribution with a d_{VS}50 value, the d_{VS}50 value being at most 200 nm, and having a surface layer with an average molar composition SiOₓ with 0<x<2, preferably 0<x<1,
b. Providing a M-based powder comprising M-based particles of one or more elements M from a group of metals that have a Standard Gibbs free energy of formation at a temperature T of the oxide from their zerovalent state which is lower than the Standard Gibbs free energy of formation at the same temperature T of SiO₂ from zerovalent silicon, the temperature T being equal to or higher than 573K and lower than 1373K, the M-based particles having a volumetric particle size distribution with a d_{M}50 value, the d_{M}50 value being at most 500 nm,
c. Mixing the silicon-based powder with the M-based powder to obtain an intermediate mixture,
d. Milling the intermediate mixture, whereby a final mixture of silicon-based particles and M-based particles is obtained,
e. Performing a heat treatment of the final mixture under protective atmosphere at a temperature equal to or higher than 573K and lower than 1373K, followed by a cooling step to room temperature.

Preferably, the M-based powder comprises Zr as the main metal element. More preferably, the M-based powder comprises only Zr as metal element, besides the unavoidable metal impurities.

By the main metal element, it is mean the metal element being present in majority, or having the largest content, compared to the other metal elements present in the M-based powder.

### Embodiment 10

In a third aspect, the invention concerns a composite powder suitable for use in a negative electrode of a battery, the composite powder comprising composite particles, the composite particles comprising a matrix material and a silicon-based powder according to any one of the Embodiments 1 to 8, the particles of said silicon-based powder being embedded in the matrix material.

Preferably the matrix material is an organic compound or a mixture of organic compounds that can be thermally decomposed to a carbon-like material, or the matrix material is a thermal decomposition product of such organic compounds or mixture of organic compounds. Examples of such compounds are: polyvinyl alcohol (PVA), polyvinyl chloride (PVC), sucrose, coal-tar pitch, petroleum pitch, lignin and resins.

By being embedded in the matrix material, it is meant that the particles of said silicon-based powder according to any one of the Embodiments 1 to 8 are dispersed in the matrix material, either without forming agglomerates, or forming agglomerates of a size smaller than 1 μm, and are covered in their majority, preferably in their entirety, by the matrix material. Hence, in the composite powder, the particles of said silicon-based powder according to any one of the Embodiments 1 to 8 may preferably be in contact only with each other and/or with the matrix material.

### Embodiment 11

In an eleventh embodiment according to Embodiment 10, the composite powder also contains graphite particles. Preferably, the graphite particles are not embedded in the matrix material.

### Embodiment 12

In a twelfth embodiment according to Embodiment 10 or 11, the composite powder has an average silicon content which is at least 5% by weight and at most 60% by weight.

The composite powder also preferably has an average oxygen content which is at most 5% by weight.

### Embodiment 13

In a thirteenth embodiment according to any one of the Embodiments 10 to 12, the composite powder has a BET specific surface area lower than 5 m²/g.

A low BET specific surface area is important to decrease the surface of electrochemically active particles in contact with the electrolyte, in order to limit the Solid Electrolyte Interphase (SEI) formation, which consumes lithium, and thus to limit the irreversible loss of capacity of a battery containing such a composite powder.

### Embodiment 14

In a fourteenth embodiment, the invention finally concerns a battery comprising the powder of any of the Embodiments 1 to 8, either or not as part of a composite powder according to any one of the Embodiments 10 to 13.

### DETAILED DESCRIPTION

In the following detailed description, preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

### Analytical Methods Used

### Determination of the Si and Zr Contents

The Si and Zr contents of the powders in the examples and the counterexamples are measured by X-Ray Fluorescence (XRF) using an energy 20 dispersive spectrometer.

### Determination of the Oxygen Content

The oxygen contents of the powders in the examples and the counterexamples are determined by the following method, using a LECO TC600 oxygen-nitrogen analyzer. A sample of the powder is put in a closed tin capsule that is put itself in a nickel basket. The basket is put in a graphite crucible and heated under helium as carrier gas to above 2000° C. The sample thereby melts and oxygen reacts with the graphite from the crucible to CO or CO₂ gas. These gases are guided into an infrared measuring cell. The observed signal is recalculated to an oxygen content.

### Determination of the Specific Surface Area (BET)

The specific surface area is measured with the Brunauer-Emmett-Teller (BET) method using a Micromeritics Tristar 3000 BET Surface Area Analyzer. 2 g of the powder to be analyzed is first dried in an oven at 120° C. for 2 hours, followed by N₂ purging. Then the powder is degassed in vacuum at 120° C. for 1 hour prior to the measurement, in order to remove adsorbed species.

### Determination of the Electrochemical Performance

The electrochemical performance of the powders in the examples and the counterexamples is determined by the following method. For the powders according to Embodiments 1 to 9, since it is necessary to avoid any contact with air or oxygen, in order not to re-oxidize the silicon-based particles, the whole preparation of the electrode and the cell is done inside a glove-box containing dry argon (<3 ppm H₂O and <3 ppm O₂). For the composite powders, since the silicon-based particles are embedded in a protective matrix, the preparation of the electrode may be done in air.

The powders to be tested are first sieved using a 45 μm sieve. They are then mixed with carbon black, optionally with carbon fibers and with a binder. In the case of the silicon-based powders according to Embodiments 1 to 9, the binder is Polyvinylidene fluoride (PVDF) dissolved in N-Methyl-2-pyrrolidone (NMP) at a concentration of 8 wt % PVDF in NMP. The composition of the electrode is 50 weight parts powder/25 weight parts carbon black/25 weight parts PVDF.

In the case of the composite powders, the binder is sodium carboxymethyl cellulose (CMC) binder dissolved in water at a concentration of 2.5 wt %. The composition of the electrode is 89 weight parts composite powder/1 weight parts carbon black/2 weight parts carbon fibers/8 weight parts CMC.

In both cases, the components are mixed in a Pulverisette 7 planetary ball-mill for 30 minutes at 250 rpm. A copper foil cleaned with ethanol is used as current collector. A 200 μm thick layer of the mixed components is coated on the copper foil. The coated copper foil is then dried for 45 minutes in vacuum at 70° C. A 1.27 cm² circle is punched from the dried coated copper foil and used as an electrode in a coin cell using lithium metal as counter electrode. The electrolyte is 1M LiPF6 dissolved in EC/DEC 1/1+2% VC+10% FEC solvents.

All coin-cells are cycled using a high precision battery tester (Maccor 4000 series) using the procedure described below, where “CC” stands for “constant current” and “CV” stands for “constant voltage”.
Cycle 1:
   Rest 6 h
   CC lithiation to 10 mV at C/10, then CV lithiation until C/100
   Rest 5 min
   CC delithiation to 1.5 V at C/10
   Rest 5 min
From cycle 2 on:
   CC lithiation to 10 mV at C/2, then CV lithiation until C/50
   Rest 5 min
   CC delithiation to 1.2 V at C/2
   Rest 5 min

The coulombic efficiency (CE) of the coin-cell, being the ratio of the capacity at delithiation to the capacity at lithiation at a given cycle, is calculated for the initial cycle as well as for the subsequent ones. The initial cycle is the most important one in terms of coulombic efficiency, since the reaction of SEI formation has a huge impact on the CE. Typically, for a silicon-based powder, the coulombic efficiency at the initial cycle can be as low as 80% (or even lower), corresponding to an irreversible capacity loss for the coin-cell of 20%, which is huge. The target is to reach at least 90% CE at the initial cycle, for which reducing the amount of oxygen present in the electrochemically active material has a beneficial effect.

To reach a desired cell capacity, a battery manufacturer needs to compensate the irreversible loss at the initial cycle caused by the anode, using additional cathode material, which represents a significant additional cost and a loss of energy density. Thus, even a little gain obtained for the CE at the initial cycle, multiplied by millions of cells produced, is significant.

### Determination of the Particle Size Distribution

The number-based particle size distribution of the silicon-based particles and/or of the non-silicon-based particles comprised in the silicon-based powders and the composite powders according to the invention is determined via an electron microscopy analysis (SEM or TEM) of a cross-section of the silicon-based powder (or the composite powder), combined with an image analysis.

To do this, a cross-section of the silicon-based powder (or the composite powder), comprising multiple cross-sections of silicon-based particles and non-silicon-based particles, is prepared following the procedure detailed hereafter.

500 mg of the powder to be analyzed is embedded in 7 g of a resin (Buehler EpoxiCure 2) consisting of a mix of 4 parts Epoxy Resin (20-3430-128) and 1 part Epoxy Hardener (20-3432-032). The resulting sample of 1″ diameter is dried during at least 8 hours. It is then polished, first mechanically using a Struers Tegramin-30 until a thickness of maximum 5 mm is reached, and then further polished by ion-beam polishing (Cross Section Polisher Jeol SM-09010) for about 6 hours at 6 kV, to obtain a polished surface. A carbon coating is finally applied on this polished surface by carbon sputtering using a Cressington 208 carbon coater for 12 seconds, to obtain the sample, also called “cross-section”, that will be analyzed by SEM (or TEM).

The size of a silicon-based particle (or a non-silicon-based particle) is considered to be equivalent to the maximum straight-line distance between two points on the perimeter of a discrete cross-section of that silicon-based particle (or non-silicon-based particle), also called dₘₐₓ.

For the purpose of illustrating, in a non-limitative way, the determination of the number-based particle size distribution of silicon-based particles (or non-silicon-based particles), a SEM-based procedure is provided below.
1. Multiple SEM images of the cross-section of the silicon-based powder (or the composite powder) comprising the silicon-based particles and the non-silicon-based particles are acquired.
2. The contrast and brightness settings of the images are adjusted for an easy visualization of the cross-sections of the silicon-based particles and the non-silicon-based particles. Due to their different chemical composition, the difference in brightness allows for an easy distinction between the two types of particles and, in case of a composite powder, with the matrix.
3. At least 1000 discrete cross-sections of silicon-based particles and at least 100 discrete cross-sections of non-silicon-based particles, not overlapping with another cross-section of a silicon-based particle or a non-silicon-based particle, are selected from one or several of the acquired SEM image(s), using a suitable image analysis software. These discrete cross-sections of silicon-based particles or non-silicon-based particles can be selected from one or more cross-sections of the powder comprising the silicon-based particles and the non-silicon-based particles.
4. dₘₐₓ values of the discrete cross-sections of the silicon-based particles and the non-silicon-based particles are measured using a suitable image analysis software for each of the at least 1000 discrete cross-sections of silicon-based particles and each of the at least 100 discrete cross-sections of non-silicon-based particles.

The d_{S}10, d_{S}50 and d_{S}90 values of the number-based particle size distribution of silicon-based particles and the d_{NS}10, d_{NS}50 and d_{NS}90 of the number-based particle size distribution of non-silicon-based particles, determined using the method described above, are then calculated. These number-based particle size distributions can be readily converted to a weight- or a volume-based particle size distribution via well-known mathematical equations.

Alternatively, the volume-based particle size distribution of the silicon-based powder may be determined by centrifugal sedimentation with the Centrifugal Photosedimentometer DC20000 (CPS Instruments, Inc, USA).

The instrument is equipped with a hollow polycarbonate disc with an internal radius of 4.74 cm. Rotational speed is set to 20000 rpm which corresponds to a centrifugal acceleration force of approx. 1.9×10⁵ m/s².

The disc is filled with 16 ml of a linear density gradient (10 to 5%) of Halocarbon 1.8 (chlorotrifluoroethylene-PCTFE) in 2-butoxyethylacetate (casrn112-07-2). As reference material—to calculate the sedimentation constant—diamond particles with a mean diameter of 0.52 μm and a specific density of 3.515 g/cm³ are used.

### Sample Preparation:

A 10 wt % suspension in Isopropanol of the powder to be analyzed is prepared using ultrasound (Branson sonifier 550W). The suspension is diluted with butoxyethylacetate to a final concentration of 0.05 weight % silicon. 0.050 ml of the resulting sample is injected in the disc and light absorbance is recorded as a function of time at a wavelength of 470 nm.

The resulting time-absorbance curve is converted to a particle size distribution (mass or volume) with a build-in algorithm (DCCS software) and using the following parameters:
Spin fluid density: 2.33 g/cm³
Spin fluid refractive index: 1.482
Silicon density: 2.33 g/cm³
Silicon refractive index: 4.49
Silicon adsorption coefficient: 17.2 K

The volume-based particle size distribution of the composite powders is determined by Laser Diffraction Sympatec (Sympatec-Helos/BFS-Magic 1812), following the user instructions. The following settings are used for the measurement:
Dispergen system: Sympatec-Rodos-M
Disperser: Sympatec-Vibri 1227
Lens: R2 (0.45-87.5 μm range)
Dispersion: Pressured air at 3 bars
Optical concentration: 3-12%
Start/stop: 2%
Time base: 100 ms
Feed rate: 80%
Aperture: 1.0 mm

It must be noted that feed rate and aperture settings can vary in function of the optical concentration.

The d_{VS}10, d_{VS}50 and d_{VS}90 values of the volume-based particle size distributions of the silicon-based powder and the d_{C}10, d_{C}50 and d_{C}90 values of the volume-based particle size distributions of the composite powder, determined using the methods described above, are then calculated.

### Analysis of the Particles Comprising the One or More Elements M

The localization of the particles comprising the one or more elements M is done based on SEM-EDS (Energy-dispersive X-ray spectroscopy) microscopy analysis with a mapping of Si, 0, C and M elements.

The cross-section is prepared following the procedure previously described and is then analyzed using a FEG-SEM JSM-7600F from JEOL equipped with an EDS detector Xflash 5030-127 from Bruker (30 mm², 127 eV). The signals from this detector are treated by the Quantax 800 EDS system from Bruker.

The enlargements are generated by applying a voltage of 15 kV at a working distance of several millimeters. The images from the backscattered electrons are reported when adding value to the images from the optical microscope.

To determine whether oxygen is bound to the elements M or Si, the oxidation state(s) of the elements M or Si is determined by X-Ray Photoemission Spectrometry (XPS) analysis using a PHI Quantera SXM spectrometer equipped with a focused monochromatized Al Kα radiation. The take-off angle used is 45°, the depth of analysis is lower than 10 nm and the spot diameter is 200 μm. The sensitivity limits are between 0.1% and 0.5% atomic. MultiPak software is used for data treatment.

The XPS analysis also allows determining the average molar composition, i.e. the average value of x, x′ in the SiOₓ and SiO_{x′} surface layer respectively and the average value of y and y′ in the MO_{y} and MO_{y′} surface layer respectively, and to estimate the thickness of those surface layers.

Alternatively, a TEM-EELS (Electron Energy Loss Spectroscopy) equipment or a Nuclear Magnetic Resonance (NMR) equipment may be used for the same purpose.

### EXPERIMENTAL PREPARATION OF COUNTEREXAMPLES AND EXAMPLES

### Example 1 (E1), According to the Invention

To produce the silicon-based powder from Example 1, a silicon powder is first obtained by applying a 60 kW radio frequency (RF) inductively coupled plasma (ICP), using argon as plasma gas, to which a micron-sized silicon powder precursor is injected at a rate of circa 50 g/h, resulting in a prevalent (i.e. in the reaction zone) temperature above 2000K. In this first process step, the precursor becomes totally vaporized. In a second process step, an argon flow of 18 Nm³/h is used as quench gas immediately downstream of the reaction zone in order to lower the temperature of the gas below 1600K, causing a nucleation into metallic submicron silicon powder. Finally, a passivation step is performed at a temperature of 100° C. during 5 minutes by adding 100 I/h of a N₂/O₂ mixture containing 1 mole % oxygen.

The specific surface area (BET) of the obtained silicon powder is measured to be 83 m²/g. The oxygen content of the obtained silicon powder is measured to be 8.7 wt %. The particle size distribution of the silicon powder is determined to be: d_{VS}10=63 nm, d_{VS}50=113 nm, d_{VS}90=205 nm and d_{avS}=119 nm.

This silicon powder is then mixed, inside a glove box (dry Ar atmosphere, <3 ppm H₂O and <3 ppm 02) to avoid oxygen contamination, in a Fritsch Pulverisette 7 planetary ball-mill, with a zirconium powder (American Elements, average particle size 50 nm-100 nm), using a rotation speed of 600 rpm, stainless steel balls with a size adapted to the jar, a ball-to-powder mass ratio (BPR) of 20:1 and a milling time of 240 minutes. The weight of zirconium powder is 0.0913% of the weight of the silicon powder, so that the content by weight of Zr is 0.1% of the content by weight of Si present in the resulting mixture.

The resulting mixed powder is further given a heat treatment, in an oven placed in the glove-box (dry Ar atmosphere, <3 ppm H₂O and <3 ppm 02) at 773 K for 2 hrs and subsequently cooled to room temperature.

Based on a SEM analysis, the average sizes of the silicon particles and the zirconium particles have not been significantly modified during the process. This means that d_{VS}10, d_{VS}50, d_{VS}90, days values and d_{S}10, d_{S}50, d_{S}90, dₐᵥ values, respectively, can be considered equal. Similarly, d_{M}10, d_{M}50, d_{M}90 values and d_{NS}10, d_{NS}50, d_{NS}90 values, respectively, can be considered equal.

The oxygen content of the mixture is measured to be 8.7 wt %, meaning that no additional oxygen intake has occurred. The specific surface area (BET) of the mixture is measured to be 83 m²/g, meaning that a content of 0.1% of Zr relative to Si does not change the BET value.

Based on an XPS analysis of the obtained silicon-based powder, the surface of the zirconium particles up to 10 nm deep is fully oxidized, meaning that the zirconium is at an oxidation state+IV. The SEM-EDS analysis of the cross-section of the obtained powder also confirms that oxygen is present in the core of the zirconium particles. Still based on an XPS analysis, the average x value in the SiOₓ surface layer of the silicon particles of the obtained silicon-based powder is lower than the average x′ value in the SiO_{x′} surface layer of the silicon particles after their production by plasma and before their mixing with the zirconium particles.

### Examples 2-5 (E2-E5), According to the Invention

To produce the silicon-based powders of Examples 2 to 5, the same procedure is used as for Example 1, except that different amounts of zirconium powder are used during the mixing step. These amounts are: 0.4 wt % for Example 2, 1.0 wt % for Example 3, 2.0 wt % for Example 4 and 5.0 wt % for Example 5, whereby these amounts are expressed as percentages compared to the Si amount present in the final silicon-based powder.

### Counterexample 1 (CE1), not According to the Invention

To produce the silicon-based powder of Counter Example 1, the same procedure as for Example 1 is used, except that no zirconium powder is added. In order to ensure maximum comparability between the examples and the counterexample, the mentioned heating step at 773K is nevertheless performed in this procedure.

All the oxygen contents of the obtained silicon-based powders (E2 to E5 and CE1) are measured to be 8.7 wt %. All the specific surface area (BET) values of the obtained silicon-based powders (E2 to E5 and CE1) range between 82 and 85 m²/g.

### Electrochemical Testing of the Powders

The produced powders are tested in coin-cells according to the procedure specified above. The following results are obtained:

TABLE 1
Performance of coin-cells containing
powders E1, E2, E3, E4, E5 and CE1

| | Zr weight content/Si | Initial coulombic efficiency |
|---|---|---|
| Example # | weight content (%) | (CE) in coin-cell (%) |
| E1 | 0.1 | 88.15 |
| E2 | 0.4 | 88.29 |
| E3 | 1.0 | 88.52 |
| E4 | 2.0 | 88.98 |
| E5 | 5.0 | 90.28 |
| CE1 | 0.0 | 88.11 |

It can be seen that there is an increase in the initial coulombic efficiency (CE) with the amount of Zr added for the coin-cells using the silicon-based powders according to the invention (E1 to E5) as anode material.

This is explained by the fact that partly due to the mixing and partly due to the subsequent heating, part of the oxygen present at the surface of the silicon particles is transferred to the zirconium particles that are present. This reduces the amount of lithium converted to lithium oxide during the initial lithiation of the anode, thereby reducing the initial irreversible capacity loss and increasing the initial coulombic efficiency (CE) of the cell.

### Example 6 (E6), According to the Invention

To produce the composite powder of Example 6, a blend is made, inside the glove-box, of 26 g of the silicon-based powder from Example 4 (E4) and 32 g petroleum-based pitch powder.

This blend is heated to 450° C. under N₂, so that the pitch melts, and, after a waiting period of 60 minutes, mixed for 30 minutes under high shear by means of a Cowles dissolver-type mixer operating at 1000 rpm.

The mixture of the silicon-based powder E4 in pitch thus obtained is cooled under N₂ to room temperature and, once solidified, pulverized and sieved on a 400-mesh sieve, to produce an intermediate composite powder.

16 g of the intermediate composite powder is then mixed with 24.6 g graphite for 3 hours on a roller bench, after which the obtained mixture is passed through a mill to de-agglomerate it. At these conditions good mixing is obtained but the graphite does not become embedded in the pitch.

A thermal after-treatment is further given to the obtained mixture of the powder from E4, the pitch and the graphite as follows: the product is put in a quartz crucible in a tube furnace, heated up at a heating rate of 3° C./min to 1000° C., kept at that temperature for two hours and then cooled. All this is performed under argon atmosphere.

The fired product is finally manually crushed in a mortar and sieved over a 325-mesh sieve to form a final composite powder.

The total Si content in this composite powder is measured to be 20.3 wt % by XRF, having an experimental error of +/−0.3 wt %. This corresponds to a calculated value based on a weight loss of the pitch upon heating of circa 40 wt % and an insignificant weight loss upon heating of the other components. The oxygen content of this composite powder was measured to be 2.0 wt %. The Zr content of this composite was measured to be 0.41 wt %, which means that the Zr/Si ratio of 2.0% has not changed. The specific surface area (BET) of the obtained composite powder is measured to be 3.6 m²/g.

### Counterexample 2 (CE2), not According to the Invention

To produce the composite powder of Counter Example 2, the same procedure as for Example 6 is used, except that the powder of Counter Example 1 (CE1) was used instead of the powder of Example 4 (E4). The oxygen content of this composite powder was measured to be 2.0 wt % and the BET value was measured to be 3.5 m²/g.

### Electrochemical Testing of the Composite Powders

The produced composite powders are tested in coin-cells according to the procedure specified above. The following results are obtained:

TABLE 2
Performance of coin-cells containing powders E6 and CE2

| | Zr weight content/Si | Initial coulombic efficiency |
|---|---|---|
| Example # | weight content (%) | (CE) in coin cell (%) |
| E6 | 2.0 | 90.08 |
| CE2 | 0.0 | 89.88 |

It can be seen that the initial coulombic efficiency (CE) of the coin-cell using the composite powder according to the invention as anode material is significantly higher than the initial coulombic efficiency of the coin-cell using the composite powder not according to the invention. In other words, the advantage observed for the silicon-based powder according to the invention, is kept when the silicon-based powder is integrated in a composite structure.

1-14. (canceled)

15. A silicon-based powder suitable for use in a negative electrode of a battery, the silicon-based powder comprising silicon-based particles and non-silicon-based particles, the silicon-based particles having a number-based particle size distribution with a d_{S}50 value, the d_{S}50 value being at most 200 nm, the silicon-based powder having an oxygen content of at most 20% by weight, the silicon-based powder comprising one or more elements M from a group of metals that have a Standard Gibbs free energy of formation at a temperature T of the oxide from their zerovalent state which is lower than the Standard Gibbs free energy of formation at the same temperature T of SiO₂ from zerovalent silicon, the temperature T being equal to or higher than 573K and lower than 1373K, the content of said one or more elements M in the silicon-based powder being at least 0.10% of the content of Si by weight in said silicon-based powder and at most 5.0% of the content of Si by weight in said silicon-based powder, the one or more elements M being present in the non-silicon-based particles.

16. A silicon-based powder according to claim 15, wherein the silicon-based particles have a surface layer with an average molar composition SiOₓ with 0≤x<1.

17. A silicon-based powder according to claim 15, wherein, when considering all elements except oxygen, the content of said one or more elements M in said non-silicon-based particles is at least 60% by weight.

18. A silicon-based powder according to claim 15, wherein said non-silicon-based particles have a number-based particle size distribution with a d_{NS}50 value, the d_{NS}50 value being at most 500 nm.

19. A silicon-based powder according to claim 15, wherein the content of said one or more elements M in said silicon-based powder is at least 0.40% of the content of Si by weight in said silicon-based powder.

20. A silicon-based powder according to claim 15, wherein the group of said one or more elements M comprises Zr.

21. A silicon-based powder according to claim 15, wherein, when considering all elements except oxygen, the Si content is at least 90% by weight.

22. A silicon-based powder according to claim 15, said powder having a volumetric particle size distribution having an average primary particle size dₐᵥ, dₐᵥ being larger than or equal to 17 nm and smaller than or equal to 172 nm.

23. A method for preparing the silicon-based powder according to claim 15, comprising the steps of:
a. providing a powder comprising silicon-based particles, having a volumetric particle size distribution with a d_{VS}50 value, the d_{VS}50 value being at most 200 nm, and having a surface layer with an average molar composition SiOₓ with 0<x<2, preferably 0<x<1,
b. providing a M-based powder comprising M-based particles of one or more elements M from a group of metals that have a Standard Gibbs free energy of formation at a temperature T of the oxide from their zerovalent state which is lower than the Standard Gibbs free energy of formation at the same temperature T of SiO₂ from zerovalent silicon, the temperature T being equal to or higher than 573K and lower than 1373K, the M-based particles having a volumetric particle size distribution with a d_{M}50 value, the d_{M}50 value being at most 500 nm,
c. mixing the silicon-based powder with the M-based powder to obtain an intermediate mixture,
d. milling the intermediate mixture, whereby a final mixture of silicon-based particles and M-based particles is obtained,
e. performing a heat treatment of the final mixture under protective atmosphere at a temperature equal to or higher than 573K and lower than 1373K, followed by a cooling step to room temperature.

24. A composite powder suitable for use in a negative electrode of a battery, wherein the composite powder comprises composite particles, the composite particles comprising a matrix material and a silicon-based powder according to claim 15, the particles of said silicon-based powder being embedded in the matrix material.

25. A composite powder according to claim 24, wherein the composite powder also contains graphite particles.

26. A composite powder according to claim 24, the composite powder having an average silicon content being at least 5% by weight and at most 60% by weight.

27. A composite powder according to claim 24, the composite powder having a BET specific surface area equal to or lower than 5 m²/g.

28. A battery comprising the silicon-based powder of claim 15.
